(19) United States
(12) Patent Application Publication
(10) Pub. No.: US 2006/0158099 A1
(43) Pub. Date: Jul. 20, 2006

(54) Thick-film electroluminescent cell

(76) Inventor: Chih-Yuan Wang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/037,371

(22) Filed: Jan. 19, 2005

(51) Int. Cl. H01J 1/62

(52) U.S. Cl. 313/503

(57) ABSTRACT

A thick-film electroluminescent cell (EL cell) including a transparent substrate, a front electrode layer, a lighting layer, an inducing layer, a back electrode layer and an insulating layer. The front electrode layer, lighting layer, inducing layer, back electrode layer and insulating layer are sequentially piled on the substrate. The lighting layer has numerous lighting powders packaged by a high-dielectric polymolecular complex material for enhancing the inductivity of the lighting powders.

### BACKGROUND OF THE INVENTION

The present invention is related to a thick-film electroluminescent cell (EL cell), and more particularly to a thick-film electroluminescent cell in which the lighting layer has numerous lighting powders packaged by a high-dielectric polymolecular complex material for creating high electric field effect to enhance the lighting efficiency.

The conventional electroluminescent cell (EL cell) is a thin sheet and mainly used as backlight cell of PDA, mobile phone, etc. FIG. 3 shows a conventional EL cell composed of a transparent substrate 81, a front electrode layer 82, a lighting layer 83, an inducing layer 84, a back electrode layer 85 and an insulating layer 86. The front electrode layer 82, lighting layer 83, inducing layer 84, back electrode layer 85 and insulating layer 86 are sequentially piled on the transparent substrate 81. By means of a driving circuit, an AC voltage is applied between the front and back electrode layers 82, 85 to induce an electric field for making the lighting powders 831 of the lighting layer 83 emit light.

The existent lighting powders 831 can be divided into two types, that is, low-voltage lighting powders and packaged lighting powders. The packaged lighting powders have better lighting effect. The main sources of the packaged lighting powders are OSRAM and Durel. In general manufacturing procedure, the lighting powders are mixed with polymolecular adhesive (such as Dupont 7155 resin) to form thick-film EL cell. Under 100V/400 Hz driving, such thick-film EL cell can only create a brightness up to 40˜60 cd/m². This brightness value cannot be further broken through.

According to the research of this applicant, the lighting efficiency of EL cell is in direct proportion to the inductive ability thereof. The higher the inductive ability of the EL cell is, the higher the lighting efficiency is. The inductive ability (that is, the capacitance) can be obtained according to the following formula:
C=ε·A/d, wherein:

ε is the inductivity,

A is the area of the inducing layer and

d is the thickness of the inducting layer.

It can be known from the above formula that by means of increasing the inductivity ε, inducing layer area A or decreasing inducing layer thickness d, the capacitance C can be increased to enhance the lighting efficiency. However, the inductivity ε and the inducing layer thickness d are the material's own properties and can be hardly changed by the existent technique. The inducing layer area A is closely related to the size of the EL cell and also hard to change. Therefore, it is difficult to enhance the lighting efficiency of the current EL cell.

It is therefore tried by the applicant to develop a technique for increasing the inductivity E so as to enhance the lighting efficiency of the EL cell.

### SUMMARY OF THE INVENTION

It is therefore a primary object of the present invention to provide a thick-film electroluminescent cell (EL cell) in which the lighting powders are packaged by a high-dielectric polymolecular complex material. When a driving circuit applies an AC voltage between the front and back electrode layers, a high electric field effect is produced, whereby the lighting powders can emit light with higher efficiency.

According to the above object, the thick-film electroluminescent cell of the present invention includes a transparent substrate, a front electrode layer, a lighting layer, an inducing layer, a back electrode layer and an insulating layer for packaging the EL cell. The front electrode layer, lighting layer, inducing layer, back electrode layer and insulating layer are sequentially piled on the substrate. The lighting layer has numerous lighting powders packaged by a high-dielectric polymolecular complex material for enhancing the inductivity of the lighting powders and creating high electric field effect to enhance the lighting efficiency.

The present invention can be best understood through the following description and accompanying drawings wherein:

### BRIEF DESCRIPTION OF THE DRAWINGS

FIG. 1 is a sectional view showing a first embodiment of the structure of the present invention;

FIG. 2 is a sectional view showing a second embodiment of the present invention; and

FIG. 3 is a sectional view showing a conventional electroluminescent cell.

### DETAILED DESCRIPTION OF THE PREFERRED EMBODIMENTS

Please refer to FIG. 1. The thick-film electroluminescent cell (EL cell) of the present invention includes a transparent substrate 11, a transparent front electrode layer 12, a lighting layer 13, an inducing layer 14, a back electrode layer 15 and an insulating layer 16 for packaging the EL cell. The transparent front electrode layer 12, lighting layer 13, inducing layer 14, back electrode layer 15 and insulating layer 16 are sequentially piled on the substrate 11. The lighting layer 13 has numerous lighting powders 131 packaged by a high-dielectric polymolecular complex material 132 for enhancing the inductivity.

The high-dielectric polymolecular complex material 132 includes halogen resin, cyanoresin, silicone resin, epoxy, acrylic resin, amino resin, rubber, polyester resin, amide resin, etc. The high-dielectric polymolecular complex material 132 can be also doped with high-dielectric inorganic material.

In this embodiment, the high-dielectric polymolecular complex material 132 is HPDR-V1 made of the above materials. The inductivity ε is larger than or equal to 16 and higher than the inductivity ε of a common resin (ε=3˜5). Moreover, the lighting powders 131 are packaged by the high-dielectric polymolecular complex material 132 by way of coating.

The lighting powders 131 are packaged by the high-dielectric polymolecular complex material 132 for enhancing the inductivity of the lighting powders 131. Therefore, when the driving circuit (not shown) applies an AC voltage between the front and back electrode layers 12, 15, a high electric field effect is produced, whereby the lighting powders 131 can emit light with higher efficiency.

According to the formula of C=ε·A/d, when the inductivity ε of the lighting powders is increased, the capacitance C will be increased. After the capacitance C is increased, the lighting efficiency is increased with the capacitance C. According to a real test of the inventor, under 100 V/400 Hz driving, the thick-film EL cell of the present invention can achieve a brightness over 60˜70 cd/m². In comparison with the conventional technique, the EL cell of the present invention can 16% increase the lighting efficiency. That is, according to the present invention, the lighting efficiency of the product can be enhanced only by means of coating the lighting powders 131 without changing the current manufacturing procedure.

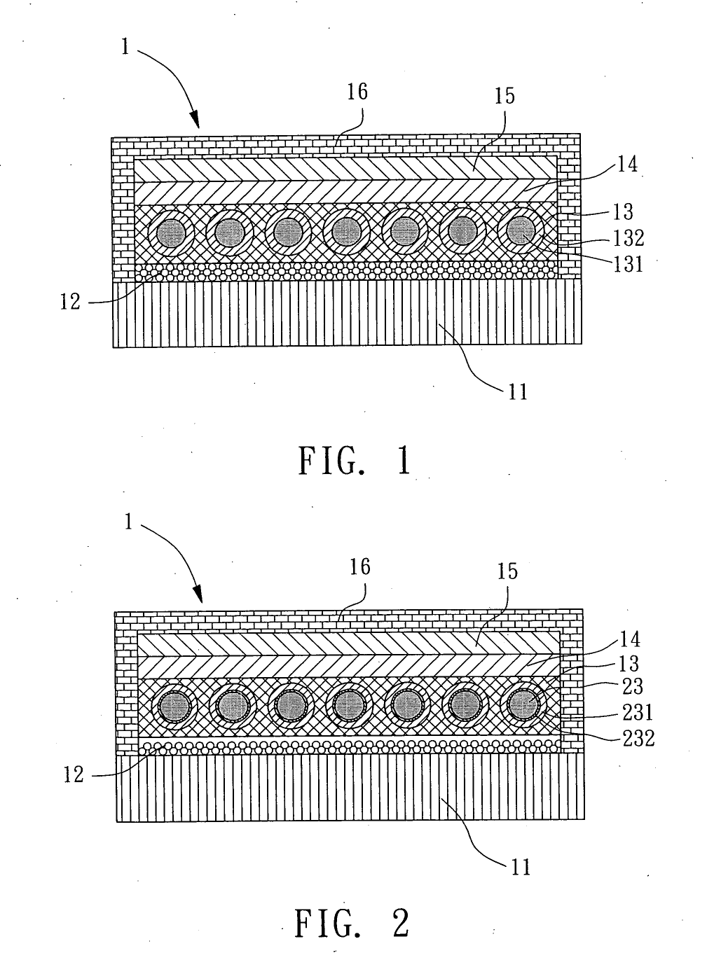

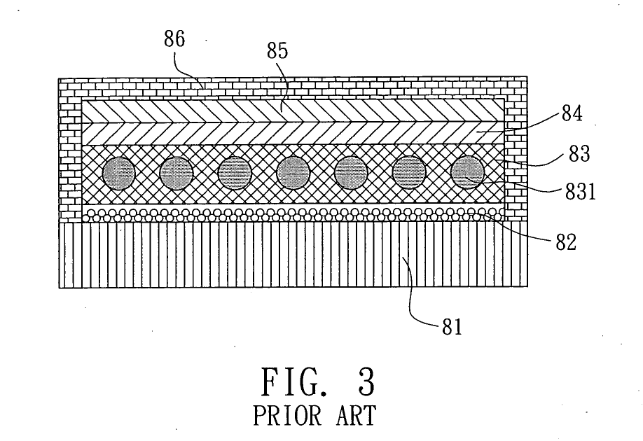

FIG. 2 shows a second embodiment of the present invention, in which the lighting powders 231 are packaged lighting powders (such as Durel 1PHS002AA). The lighting powders 231 are coated with a packaging layer 233. In this embodiment, the packaging layer is formed of inorganic material (such as Dupont 7155 resin). The packaging layer 233 is packaged with the high-dielectric polymolecular complex material 132. This can achieve the same effect as the first embodiment.

The above embodiments are only used to illustrate the present invention, not intended to limit the scope thereof. Many modifications of the above embodiments can be made without departing from the spirit of the present invention.

What is claimed is:

1. A thick-film electroluminescent cell (EL cell) comprising a transparent substrate, a front electrode layer, a lighting layer, an inducing layer, a back electrode layer and an insulating layer for packaging the EL cell, the front electrode layer, lighting layer, inducing layer, back electrode layer and insulating layer being sequentially piled on the substrate, the lighting layer having numerous lighting powders packaged by a high-dielectric polymolecular complex material for enhancing the inductivity of the lighting powders.

2. The thick-film electroluminescent cell (EL cell) as claimed in claim 1, wherein the lighting powders are packaged lighting powders, the lighting powders being coated with a packaging layer, the packaging layer being packaged with the high-dielectric polymolecular complex material.

3. The thick-film electroluminescent cell (EL cell) as claimed in claim 1, wherein the high-dielectric polymolecular complex material includes halogen resin, cyanoresin, silicone resin, epoxy, acrylic resin, amino resin, rubber, polyester resin, amide resin, etc.

4. The thick-film electroluminescent cell (EL cell) as claimed in claim 2, wherein the packaging layer is formed of inorganic material.

5. The thick-film electroluminescent cell (EL cell) as claimed in claim 3, wherein the high-dielectric polymolecular complex material is doped with high-dielectric inorganic material.
